(19) United States
(12) Patent Application Publication
(10) Pub. No.: US 2021/0133537 A1
(43) Pub. Date: May 6, 2021

(54) TRANSLATION METHOD AND APPARATUS THEREFOR

(71) Applicant: LLSOLLU CO., LTD., Seoul (KR)

(72) Inventors: Myeongjin HWANG, Seoul (KR); Changjin JI, Seoul (KR)

(73) Assignee: LLSOLLU CO., LTD., Seoul (KR)

(21) Appl. No.: 16/766,644

(22) PCT Filed: Nov. 30, 2017
(86) PCT No.: PCT/KR2017/013919

§ 371 Date: May 22, 2020

(51) Int. Cl. G06N 3/04

(52) U.S. Cl. CPC G06N 3/049; G06N 3/0454; G06N 3/0445

(57) ABSTRACT

A translation method and an apparatus therefor are disclosed. Particularly, a method of performing sequence-to-sequence translation may include dividing an entire input into input units for each time point, the input units being units subjected to translation, inserting, into a corresponding one of the input units, a first symbol indicating a position of a symbol to be assigned a highest weight among symbols belonging to the corresponding input unit, and repeatedly deriving an output symbol from the input unit in which the first symbol is inserted each time the time point is increased.

### TECHNICAL FIELD

The present disclosure relates to a sequence-to-sequence translation method, and more particularly, to a method for implementing a modeling technique for sequence-to-sequence translation and an apparatus supporting the same.

### BACKGROUND ART

A sequence-to-sequence translation technique is a technique of translating an input of a string/sequence type into another string/sequence. It can be used in machine translation, automatic summarization, and various kinds of language processing. However, it may actually be recognized as any operation for receiving a sequence of input bits through a computer program and outputting a sequence of output bits. That is, every single program may be referred to as a sequence-to-sequence model representing a particular operation.

Recently, deep learning techniques, which provide high quality of sequence-to-sequence translation modeling, have been introduced. Typically, a recurrent neural network (RNN) and a time delay neural network (TDNN) are used.

### DISCLOSURE

### Technical Problem

It is one object of the present disclosure to provide a window shifted neural network (hereinafter AWSNN) modeling technique with heuristic attention.

It is another object of the present disclosure to provide a method of adding a point (vertex) that can explicitly express a translation point in a conventional window shift based model such as a TDNN.

It is another object of the present disclosure to provide a learning structure capable of performing a function like attention of neural machine translation (NMT), which uses an RNN.

The objects to be achieved in the present disclosure are not limited to those mentioned above. Additional objects and features of the disclosure will be set forth in part in the description which follows and in part will become apparent to those having ordinary skill in the art upon examination of the following.

### Technical Solution

In accordance with one aspect of the present disclosure, provided is a method of performing sequence-to-sequence translation, the method including dividing an entire input into input units for each time point, the input units being units subjected to translation, inserting, into a corresponding one of the input units, a first symbol indicating a position of a symbol to be assigned a highest weight among symbols belonging to the corresponding input unit, and repeatedly deriving an output symbol from the input unit in which the first symbol is inserted each time the time point is increased.

In accordance with another aspect of the present disclosure, provided is an apparatus for performing sequence-to-sequence translation, including a processor configured to divide an entire input input to the apparatus into input units for each time point, the input units being units subjected to translation, insert, into a corresponding one of the input units, a first symbol indicating a position of a symbol to be assigned a highest weight among symbols belonging to the corresponding input unit, and repeatedly derive an output symbol from the input unit in which the first symbol is inserted each time the time point is increased.

A position of the first symbol within the input unit may remain fixed as the position of the first symbol rises according to increase of the time point.

An output symbol from a time point before a current time point may be inserted subsequent to original symbols in the input unit.

A second symbol for distinguishing the original symbols in the input unit from the output symbol inserted in the input unit may be inserted in the input unit.

A third symbol for indicating an end point of the output symbol inserted in the input unit may be inserted in the input unit.

### Advantageous Effects

According to an embodiment of the present disclosure, in sequence-to-sequence translation that requires only narrow-context information, adverse effects may be reduced and accuracy may be improved.

The effects obtainable in the present disclosure are not limited to the above-mentioned effects, and other effects not mentioned herein will be clearly understood by those skilled in the art from the following description.

### DESCRIPTION OF DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 illustrates a typical time delay neural network (TDNN);

FIG. 2 illustrates single time-delay neurons (TDN) with N delays for each of M inputs at time t

FIG. 3 illustrates the overall architecture of the TDNN;

FIGS. 4 and 5 illustrate an exemplary sequence translation method according to an embodiment of the present disclosure;

FIGS. 6 and 7 illustrate another exemplary sequence translation method according to an embodiment of the present disclosure;

FIG. 8 illustrates a sequence translation method performing sequence-to-sequence translation according to an embodiment of the present disclosure; and

FIG. 9 is a block diagram illustrating a configuration of a sequence translation apparatus for performing sequence-to-sequence translation according to an embodiment of the present disclosure.

### BEST MODE

Hereinafter, preferred embodiments of the present invention will be described in detail with reference to the accompanying drawings. The detailed description set forth below, in conjunction with the accompanying drawings, is intended to describe exemplary embodiments of the invention, and is not intended to represent the only embodiments in which the invention may be practiced. The following detailed description includes specific details to provide a thorough understanding of the present invention. However, one skilled in the art will appreciate that the present invention can be practiced without these specific details.

In some cases, in order to avoid obscuring the concept of the present disclosure, description of well-known structures and devices may be skipped, or block diagrams centered on the core functions of each structure and device may be illustrated.

In the present disclosure, a sequence-to-sequence translation method using heuristic attention is provided.

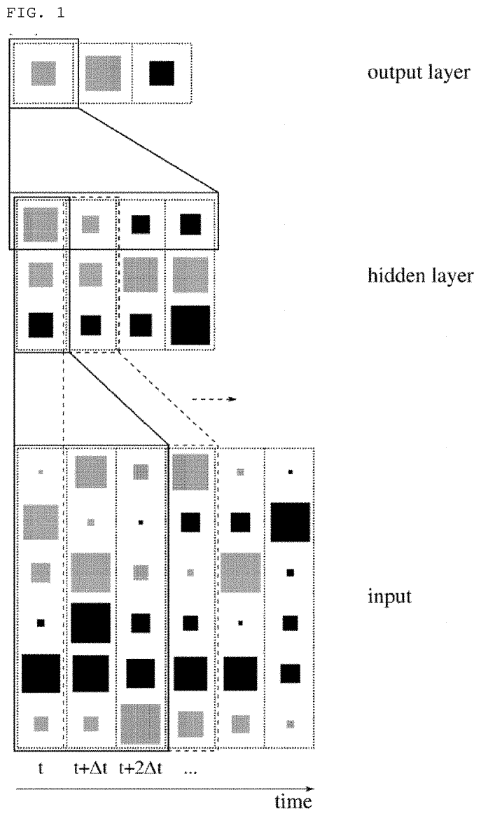

FIG. 1 illustrates a typical time delay neural network (TDNN).

A TDNN is an artificial neural network structure that is mainly intended to shift-invariantly classify a pattern that does not require explicit predetermination of the start and end points of the pattern. The TDNN has been proposed to classify phonemes within a speech signal to enable automatic speech recognition, and is difficult or impossible to automatically determine an exact segment or feature boundary. The TDNN recognizes phonemes and their fundamental acoustic/sound characteristics, regardless of a time-shift, that is, temporal positions.

The input signal augments a delayed copy to another input, and the neural network, which has is no internal state, time-shift-invariant.

Like other neural networks, the TDNN operates in multiple interconnected layers of clusters. These clusters are intended to represent neurons in the brain. Similar to the brain, each cluster needs to focus only on a small area of input. A typical TDNN has three cluster layers: a layer for input, a layer for output, and an intermediate layer to handle manipulation of input through filters. Due to sequential characteristics thereof, the TDNN is implemented as a feedforward neural network, not as a recurrent neural network.

To achieve time-shift invariance, a set of delays is added to the input (e.g., an audio file, an image, etc.) such that data is represented at different times. These delays are arbitrary and applied only to a specific application, which generally means that the input data is user-defined according to a specific delay pattern.

Efforts have been made to build an adaptable time-delay neural network (ATDNN) that eliminates manual tuning. A delay is an attempt to add a time dimension to a network that does not exist in a recurrent neural network (RNN) with a sliding window or in multilayer perceptron (MLP). Combination of past and present inputs makes the TDNN approach unique.

The core function of the TDNN is to represent the relationship between inputs over time. This relationship may be the result of a characteristics detector and is used within the TDNN to recognize a pattern between delayed inputs.

One of the main advantages of neural networks is that their dependence on prior knowledge to establish a bank of filters at each layer is weak. However, this requires that the network learn the optimal values for these filters by processing numerous training inputs. Supervised learning generally corresponds to a learning algorithm associated with the TDNN due to strength in pattern recognition and function approximation thereof. Supervised learning is usually implemented with a back propagation algorithm.

Referring to FIG. 1, a hidden layer derives a result for a part spanning from a specific point T to T+2ΔT among the entire input of the input layer, and repeats this process up to an output layer. That is, a unit (box) of the hidden layer is derived by summing values obtained by adding a bias value to a product of a weight and each unit (box) from a specific point T to T+2ΔT in the entire input of the input layer.

Hereinafter, in the description of the present disclosure, for simplicity, blocks at respective times in FIG. 1 (i.e., T, T+ΔT, T+2ΔT, . . . ) are referred to as symbols, though they may be referred to as frames or feature vectors. In terms of semantics, they may correspond to phonemes, morphemes, syllables, or the like.

In FIG. 1, the input layer has three delays, and the output layer is calculated by integrating four frames of phoneme activation the hidden layer.

FIG. 1 is merely an example, and the number of delays and the number of hidden layers are not limited thereto.

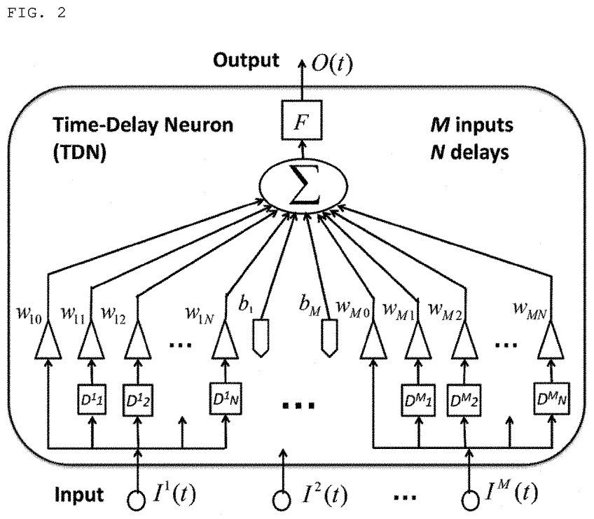

FIG. 2 illustrates single time-delay neurons (TDN) with N delays for each of M inputs at time t.

In FIG. 2, D_{d}^{j} is a register that stores the values of delayed input Iⁱ(t−d).

As described above, the TDNN is an artificial neural network model in which all units (nodes) are fully-connected by direct connection. Each unit is time-varying and has real-valued activation, and each connection has a modifiable real-valued weight. The nodes in the hidden layer and the output layer correspond to a time-delay neuron (TDN).

A single TDN has M inputs (I¹(t), I²(t), . . . , I^{M}(t)) and one output (O(t)). These inputs are a time series according to time step t. For each input Iⁱ(t) (i=1, 2, . . . M), one bias value bᵢ, N delays (D₁ⁱ, . . . , Dₙ^{j} in FIG. 2) to store previous inputs Iⁱ(t−d) (d=1, . . . , N), and N related independent weights (wᵢ₁, wᵢ₂, . . . , and w_{iN}) are given. F is a translation function f(x) (FIG. 2 exemplarily shows a nonlinear sigmoid function). A single TDN node may be represented by Equation 1 below.

$$O ( i ) = f ( {\sum }_{i - I}^{M} [ {\sum }_{d - e}^{N} {I}^{′} ( i - d ) \times {w}_{id} + {b}_{i} ] ) \qquad [ Equation 1 ]$$

In Equation 1, the inputs at the current time step t and the inputs at the previous time step t−d (d=1, . . . , N) are reflected in the entire output of the neuron. A single TDN may be used to model a dynamic nonlinear behavior characterized by a time series of Inputs.

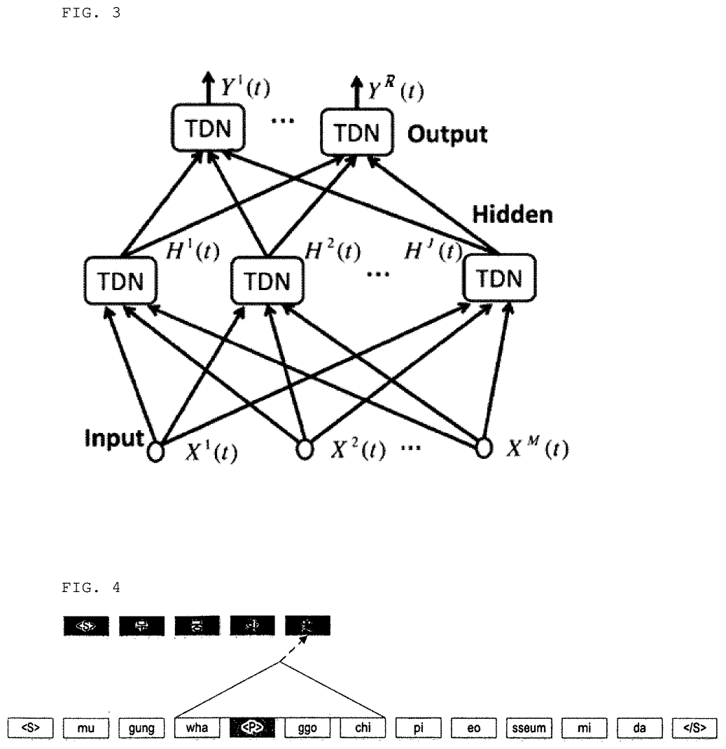

FIG. 3 illustrates the overall architecture of the TDNN.

FIG. 3 exemplarily shows a fully-connected neural network model having TDNs, wherein the hidden layer has J TDNs, and the output layer has R TDNs.

The output layer may be represented by Equation 2 below, and the hidden layer may be represented by Equation 3 below.

$$\begin{matrix}{O}^{r} ( t ) = f ( {\sum }_{j = 1}^{J} ⌈ {\sum }_{a = 0}^{{N}_{1}} {H}^{j} ( t - d ) \times {v}_{jd}^{r} + {c}_{j}^{r} ⌉ ) , r = 1 , 2 , … , R & [ Equation 2 ] \\ {H}^{j} ( t ) = f ( {\sum }_{i = 1}^{M} [ {\sum }_{d = 0}^{{N}_{2}} {X}^{j} ( t - d ) \times {w}_{id}^{j} + {b}_{i}^{j} ] ) , j = 1 , 2 , … , J & [ Equation 3 ]\end{matrix}$$

In Equations 2 and 3, w_{id}^{j} is a weight of the hidden node H^{j} having bᵢ^{j}, and v_{jd}^{t′} s a weight of the output node O^{r} having the bias value cⱼ^{r}.

As can seen from Equations 2 and 3, the TDNN is a fully-connected forward-feedback neural network model having delays in the nodes of the hidden layer and the output layer. The number of delays for the nodes in the output layer is N₁, and the number of delays for the nodes in the hidden layer is N₂. A network having the delay parameter N differing between the nodes may be referred to as a distributed. TDNN.

Supervised Learning

For supervised learning, in discrete time setting, a training set sequence of real-valued input vectors (representing, for example, a sequence of video frame features) is an activation sequence of an input node having one input vector at a time. At any given time step, each non-input unit calculates the current activation as a nonlinear function of the weighted sum of activations of all connected units. In supervised learning, the target label of each time step is used in calculating errors. The error of each sequence is the sum of deviations of activations calculated by the network at the output node of the target label. For the training set, the total error is the sum of errors calculated for the individual input sequences. The training algorithm is designed to minimize this error.

As described above, the TDNN is a model suitable for the purpose of deriving a good result that is not local by repeating the process of deriving a significant value in a limited area and repeating the same process again with the derived result.

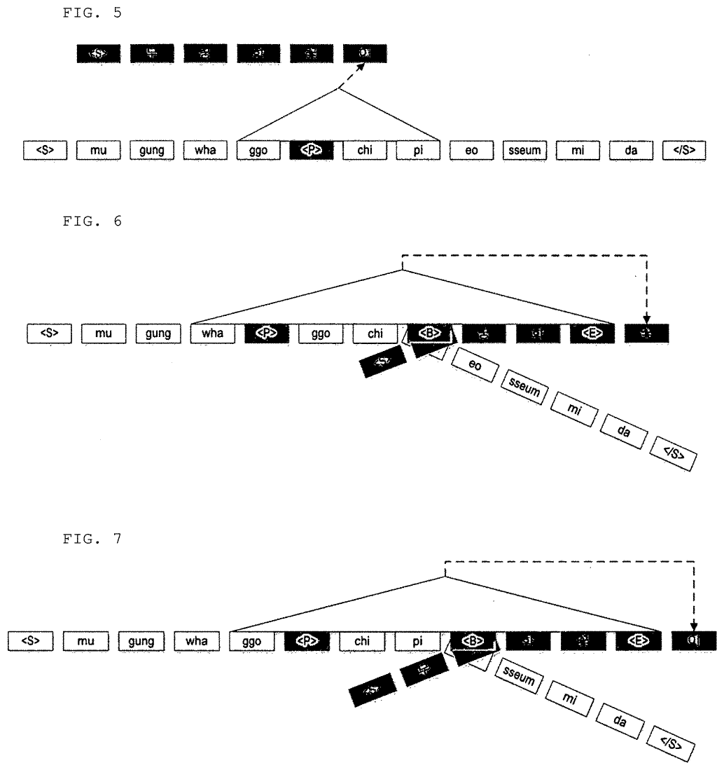

FIGS. 4 and 5 illustrate an exemplary sequence translation method according to an embodiment of the present disclosure.

In FIGS. 4 and 5, <S> is a symbol indicating the start of a sentence, and </S> is a symbol indicating the end of the sentence.

The triangle shown in FIGS. 4 and 5 may correspond to, for example, multilayer perceptron (MLP) or a convolutional neural network (CNN). However, embodiments are not limited thereto, and various models for deriving/calculating a target sequence from an input sequence may be used.

In FIGS. 4 and 5, the base of the triangle corresponds to a span from T to T+2ΔT in FIG. 1. The upper vertex of the triangle corresponds to the output layer in FIG. 1.

Referring to FIG. 4, “ [symbol] (GG0T;)” may be derived from “wha ggo chi”, and referring to FIG. 5, “ [symbol] (I;)” may be derived from “ggo chi pi”.

In FIG. 4, any of “ [symbol] (HWA;)”, “ [symbol] (I;)” or “ [symbol] (CHI;)” should not be derived from “wha ggo chi”. Further, in FIG. 5, any of “ [symbol] (GG0;)”, “ [symbol] (GG0T;)” or “ [symbol] (PI;)” should not be derived from “ggo chi pi”.

It takes a lot of time to perform learning with the conventional TDNN to prevent such erroneous outputs from being derived. In addition, the results of learning may not significantly improve accuracy.

In order to easily address such inefficiency, a translation technique according to the present disclosure (for example, the window shifted neural network with heuristic attention (hereinafter AWSNN)) may directly indicate a point (a first symbol (vertex), <P>) to focus on the current time. That is, a symbol <P> indicating a point to focus on within an input unit (i.e., the input from T to T+2ΔT in the example of FIG. 1) to which sequence-to-sequence translation is currently applied may be added to/inserted into the corresponding input sequence.

This operation is possible in the AWSNN because the input and output units have a one-to-one correspondence relationship. Of course, the number of letters or words may not fit the one-to-one correspondence.

When the time T at which the sequence-to-sequence translation is performed changes to T+1, the time/position of the symbol <P> indicating a point to focus on in the corresponding input unit is also changed by +1. In other words, from the perspective of the AWSNN, <P> always remains in the same position within the input unit.

In the AWSNN, a symbol positioned after the symbol <P> may be assigned a larger weight (e.g., the largest weight) than the other symbols belonging to the input unit.

FIGS. 6 and 7 illustrate another exemplary sequence translation method according to an embodiment of the present disclosure.

In FIGS. 6 and 7, <S> is a symbol indicating the start of a sentence, and </S> is a symbol indicating the end of the sentence.

In FIGS. 6 and 7, the triangle may correspond to a multilayer perceptron (MLP) or a convolutional neural network (CNN).

In FIGS. 6 and 7, the base of the triangle corresponds to the span from T to T+2ΔT in FIG. 1. In addition, the upper vertex of the triangle corresponds to the output layer in FIG. 1.

FIGS. and 7 are similar to FIGS. 4 and 5 described above. However, the difference is that the last part of the immediately previous output is used again as an input.

Referring to FIG. 6, it is illustrated that “ [symbol] (GUNG; HWA;)”, which is an output generated immediately before the original input “wha ggo chi”, is used again as an input after the original input.

Referring to FIG. 7, it is illustrated that “ [symbol] (HWA; GG0T;)”, which is an output generated immediately before the original input “ggo chi pi”, is used again as an input after the original input.

While FIGS. 6 and 7 illustrate that two symbols of the immediately previous output are used as an input, this is merely for convenience of description and embodiments are not necessarily limited to two symbols.

According to an embodiment of the present disclosure, a second symbol (vertex) <B> may be added to distinguish the input obtained from the immediately previous output from the original input. That is, a symbol <B> indicating a point between the input from the immediately previous output and the original input may be added/inserted to the corresponding input unit.

Alternatively, third symbol (vertex)<E> may be added to indicate the end of the input obtained from the output (the boundary adjoining a new output). That is, the symbol <E> indicating the end of the input obtained from the immediately previous output may be added to/inserted into the corresponding input, unit.

In addition, <B> may be added to/inserted into each input unit between the part corresponding to <B> and the part corresponding to <E>.

While FIGS. 6 and 7 illustrate that all of the first point P, the second point B, and the third point B are used, only one or more of the three points may be used.

The initial part, which has no previous output, may be padded with the second point B and/or the third point E.

Here, the points (P, B, and E) may have any values as long as they are distinguished from each other and from other input units. In other words, they do not need to be P, B, E. Nor do they need to be signs that should be indicated by characters.

Each point according to the present disclosure performs a function like attention of artificial neural network based neural machine translation (NMT), which employs a recurrent neural network (RNN). In other words, each point serves to explicitly indicate a portion to focus on.

A sequence translation method according to an embodiment of the present disclosure will be described in more detail.

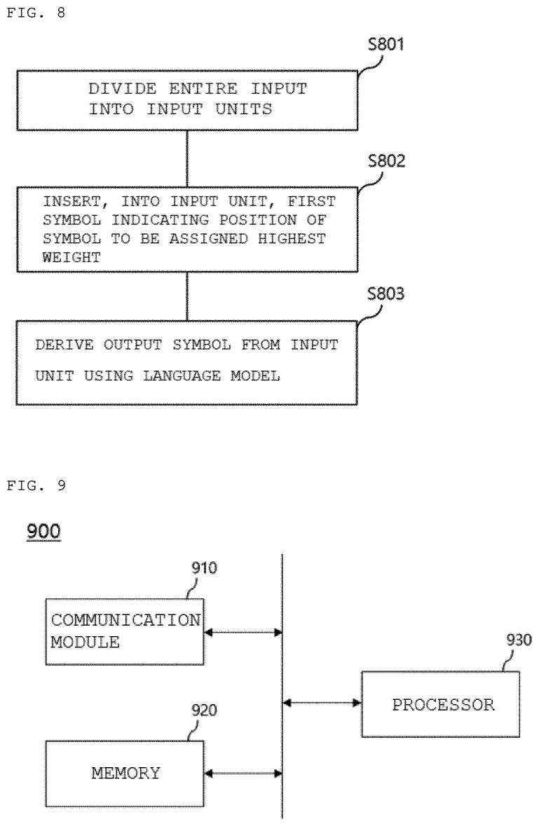

FIG. 8 illustrates a sequence translation method for performing sequence-to-sequence translation according to an embodiment of the present disclosure.

Referring to FIG. 8, a sequence translation apparatus divides an entire input into input units, which are units on which translation is performed at each time (S801).

Here, as illustrated in FIG. 1, an input unit may be a unit within a span from a specific point T to T+2ΔT among all input units. Then, when t is changed (increased), the input unit may be changed along therewith.

The sequence translation apparatus inserts, in the input unit, a first symbol (i.e., <P>) indicating the position of a symbol that is to be assigned the highest weight among the symbols belonging to the input unit (S802).

Here, when the time increases (by, for example, +1), the position of the first symbol increases (by, for example, +1), and thus the position of the first symbol in the input unit may remain fixed.

In addition, subsequent to the original symbols, an output symbol obtained at a time (e.g., t-1, t-2) before the current time (e.g., t) may be inserted into the input unit by the sequence translation apparatus.

Further, the sequence translation apparatus may insert, in the input unit, a second symbol (i.e., <B>) to distinguish the original symbols the input unit from the output symbol inserted in the input unit.

In addition, the sequence translation apparatus may insert, the input unit, a third symbol (i.e., <E>) for indicating the end point of the output symbol inserted in the input unit.

The sequence translation apparatus repeatedly derives an output symbol from the input unit in which the first symbol is inserted each time the time point is increased (S803).

The sequence translation apparatus may derive an output symbol for the entire input sequence by repeatedly deriving output symbols for each input unit as described above.

The configuration of the sequence translation apparatus according to the embodiment of the present disclosure will be described in detail.

FIG. 9 is a block diagram illustrating configuration of a sequence translation apparatus for Performing sequence-to-sequence translation according to an embodiment of the present disclosure.

Referring to FIG. 9, a sequence translation apparatus 900 according to an embodiment of the present disclosure includes a communication module 910, a memory 920, and a processor 930.

The communication module 910 is connected to the processor 930 to transmit and/or receive signals to/from external devices in a wired/wireless manner. The communication module 910 may include a modem configured to modulate a signal to be transmitted and demodulate a received signal to transmit and receive data. In particular, the communication module 910 may forward a voice signal or the like received from an external device to the processor 930, and may transmit text or the like received from the processor 930 to the external device.

Alternatively, an input unit and an output unit may be included in place of the communication module 910. In this case, the input unit may receive a voice signal or the like and forward the same to the processor 930, and the output unit may output text or the like received from the processor 930.

The memory 920 is connected to the processor 930 and serves to store information, programs, and data necessary for operation of the sequence translation apparatus 900.

The processor 930 implements the functions, processes, and/or methods proposed in FIGS. 1 to 8 described above. In addition, the processor 930 may control a signal flow between the internal blocks of the sequence translation apparatus 900 described above and perform a data processing function of processing data.

Embodiments according to the present disclosure may be implemented by various means, for example, hardware, firmware, software, a combination thereof. For implementation by hardware, one embodiment of the disclosure includes one or more application specific integrated circuits (ASICs), digital signal processors (DSPs), digital signal processing devices (DSPDs), programmable logic devices (PLDs), FPGAs (field programmable gate arrays), processors, controllers, microcontrollers, microprocessors, and the like.

For implementation by firmware or software, an embodiment of the present disclosure may be implemented in the form of a module, procedure, function, or the like that performs the functions or operations described above. Software code may be stored in the memory and driven by a processor. The memory is arranged inside or outside the processor, and may exchange data with the processor by various known means.

It will be apparent to those skilled in the art that the present disclosure may be embodied in other specific forms without departing from the essential features of the present disclosure. Therefore, the above detailed description should not be construed as limiting in all respects and should be considered illustrative. The scope of the disclosure should be determined by rational interpretation of the appended claims. Thus, it is intended that the present disclosure cover the modifications and variations of this disclosure provided they come within the scope of the appended claims and their equivalents.

### INDUSTRIAL APPLICABILITY

The present invention is applicable to various fields of machine translation.

1. A method of performing sequence-to-sequence translation, the method comprising:
dividing an entire input into input units for each time point, the input units being units subjected to translation;
inserting, into a corresponding one of the input units, a first symbol indicating a position of a symbol to be assigned a highest weight among symbols belonging to the corresponding input unit; and
repeatedly deriving an output symbol from the input unit in which the first symbol is inserted each time the time point is increased.

2. The method of claim 1, wherein a position of the first symbol within the input unit remains fixed as the position of the first symbol rises depending on increase of the time point.

3. The method of claim 1, wherein an output symbol from a time point before a current time point is inserted subsequent to original symbols in the input unit.

4. The method of claim 3, wherein a second symbol for distinguishing the original symbols in the input unit from the output symbol inserted in the input unit is inserted in the input unit.

5. The method of claim 3, wherein a third symbol for indicating an end point of the output symbol inserted in the input unit is inserted in the input unit.

6. An apparatus for performing sequence-to-sequence translation, comprising a processor configured to: divide an entire input input to the apparatus into input units for each time point, the input units being units subjected to translation; insert, into a corresponding one of the input units, a first symbol indicating a position of a symbol to be assigned a highest weight among symbols belonging to the corresponding input unit; and repeatedly derive an output symbol from the input unit in which the first symbol is inserted each time the time point is increased.
